(19) United States
(12) Patent Application Publication
(10) Pub. No.: US 2015/0314506 A1
(43) Pub. Date: Nov. 5, 2015

(54) COMPONENT WITH SEALING PLUG AND METHOD FOR MOULDING A COMPONENT INSERT

(71) Applicant: BÖLLHOFF VERVINDUNGSTECHNIK GMBH, Bielefeld (DE)

(72) Inventors: Michael Stumpf, Bielefeld (DE); Holger Thommes, Strohn (DE)

(21) Appl. No.: 14/435,078

(22) PCT Filed: Oct. 10, 2013
(86) PCT No.: PCT/EP2013/071144

§ 371 Date: Apr. 10, 2015

(30) Foreign Application Priority Data
Oct. 10, 2012 (DE) 10 2012 019 849.3

(51) Int. Cl. B29C 45/26; B29C 45/14

(52) U.S. Cl. CPC B29C 45/2608; B29C 45/14; B29C 45/14065; B29C 2045/14131; B29C 2045/14934

(57) ABSTRACT

The present invention discloses a component insert 50 with a sealing plug 1 such that the component insert is mouldable into flowable, curable or hardenable material or into materials which are soaked with flowable, hardenable liquids. The sealing plug 1 seals the component insert 50 (in this case a wire thread insert) against the ingress of the flowable, curable or hardenable material.

### 1. FIELD OF THE INVENTION

The present invention relates to a component insert with a sealing plug, wherein the component insert is mouldable into at least a flowable, curable or hardenable material or into a fibrous material soakable therewith. Further, the present invention relates to a sealing plug for the insertion into the component insert, and furthermore to a method for moulding the component insert into the at least one flowable, curable or hardenable material or into a fibrous material soakable therewith.

### 2. BACKGROUND OF THE INVENTION

In construction technology, most different components are produced from flowable, curable or hardenable materials. These flowable, curable or hardenable materials include, for example, synthetic resins, plastics or metals, such as low-melting metal cast alloys. In addition, it is known to soak and cure or harden fibrous materials with such flowable, curable or hardenable materials as for example synthetic resins, glues or adhesives to produce in this manner a fiber-reinforced plastic.

As components produced in this manner have to be connected to other components or other parts have to be fixed thereto, it is necessary to provide a threaded opening in the components. However, since the component material often has a lower strength than the material of a threaded bolt to be screwed in, such threaded openings or connecting holes may be damaged easily. To avoid such damage, component inserts, such as threaded inserts in the form of threaded sleeves or also wire thread inserts of known type, are used in such openings.

When using wire thread inserts or solid-walled threaded inserts with wall openings or through-holes, of course it has to be avoided that the liquid, curable or hardenable material enters the inside of the wire thread insert. Therefore, DE 10 14 938 proposes to profile the cross-section of the abutting turns of the wire thread insert so as to form a form-fitting and in this way sealing connection in the form of a wire threaded sleeve. Wire thread inserts with this design are complex and thus expensive in their production. In contrast thereto, CH 251 484 suggests to provide a wire thread insert with a sealing layer at its radially outer side. This layer shall prevent a liquid material from entering the interior of the wire thread insert.

EP 1 046 446 B1 describes a method in which a helically wound wire is moulded into liquid metal under axial compression. The axial compression has the objective that the adjacent turns of the wire coil abut each other sealingly. Only when this condition is reached, liquid metal is transported into the vicinity of the wire coil so that a metal part corresponding to the mould cavity may be formed. As even at wire coils produced with low tolerances the likelihood of a certain leakage in the compressed coils thereof exists, the method described here is associated with a high rejection rate.

DE 690 00 297 T2 describes a nut plate which is affixed on a component surface by means of a fixation pin. The fixation pin has two opposite mounting ends that facilitate a threading of the nut plate with lining sleeve and lining nut onto the fixation pin. The fixation pin has two radially flared or expanded portions between which a radially tapered portion is arranged. By arranging the nut between the radially flared portions, the interior of the nut is sealed against the ingress of adhesive. After the application of adhesive, the entire nut assembly group is pulled against the mounting surface by means of the fixation pin until the adhesive is cured or hardened. Thereafter, the fixation pin may be removed from the nut by being pulled out of the nut against the insertion direction at its mounting end. At this, one of the radially flared portions is overcome. Such a fixation pin is due to its construction and the methods disclosed herein merely suitable for fixing assembly groups on a surface.

It is the object of the present invention to provide a device and a method by means of which a component insert is mouldable into a flowable, curable or hardenable material or into a fibrous material soakable therewith without damaging any opening existing in the component insert or for example an internal thread by the flowable, curable or hardenable material.

### 3. SUMMARY OF THE INVENTION

The above object is achieved by a component insert with a sealing plug according to independent patent claim 1. Further, the present invention discloses a sealing plug according to independent patent claim 9 and a method for moulding a component insert with such a sealing plug into at least a flowable, curable or hardenable material or into a fibrous material soakable therewith in independent patent claim 15. Advantageous embodiments and advantages of the present invention will become apparent from the following description, the drawings and the appending claims.

The component insert according to the invention comprises a sealing plug so that the component insert with sealing plug is mouldable into at least one flowable, curable or hardenable material or into a fibrous material soakable therewith, wherein an inner side of the component insert is keepable or maintainable free of the material. In order to fulfill this purpose, the sealing plug has the following features: a cylinder-like sealing body having a radial outer side which is adaptable to the inner side of the component insert, wherein the sealing plug comprises at least one removable mounting aid at a closed end of the sealing body, so that the sealing plug is insertable into the component insert with the mounting aid rushing ahead.

The present invention comprises known component inserts that are combined with a sealing plug according to the invention. These component inserts comprise for example wire thread inserts or threaded inserts made of solid material, The component inserts are characterized by the fact that they have a through hole and/or perforated sidewalls and/or a shell opening that may be filled with this curable material during a moulding process into a curable material or into a combination of materials. Since such a tilling of the openings in the component insert would be disadvantageous, the sealing plug prevents the flowable, curable or hardenable material from reaching the inner side of the component insert.

In order to prevent, for example in radially broken threaded inserts made of solid material or similar components and in the same way at wire thread inserts, that the flowable, curable or hardenable material enters the interior of the component insert, the cylinder-like sealing body of the sealing plug is inserted into the interior of the component insert by means of the mounting aid. Since the cylinder-like sealing body is adapted in its shape preferably to the inner opening of the component insert, the radial outer side of the cylinder-like sealing body abuts independently on account of its elasticity on the radial inner side of the component insert. If the sealing body does not abut independently on the inner side of the component insert, it is alternatively also preferred to expand or widen the sealing body within the component insert. This is done for example by means of a core pin and its outer design, which is arranged in the interior of the sealing body. Another alternative is to expand or widen the sealing body by a medium such as air to press it in this way against the inner side of the component insert. According to an embodiment, this medium is introduced into the sealing body of the sealing plug via the core pin. Due to the abutment of the sealing plug on the inner side of the component insert, a sealing of the interior of the component insert against the flowable, curable material takes place, which possibly enters or presses in from the outside.

The sealing plug is also characterized by its removable mounting aid, by means of which one may pull the sealing body into the interior of the component insert. In order that the mounting aid does not interfere with the production of the component with component insert, it is removable from the sealing body, and thus from the entire sealing plug. It is also preferred to leave or maintain the mounting aid on the sealing body, provided that it is mouldable into the surrounding material of the component insert or wire thread insert.

According to a preferred embodiment of the present invention, the sealing body comprises a radially circumferential sealing lip and/or a front-end sealing surface at the end facing away from the mounting aid. While the end of the sealing body adjacent to the mounting aid is closed, the sealing lip or the front-end sealing surface arranged at the opposite end of the sealing plug ensures that flowable, curable material cannot enter the interior of the component insert from this side. A front-end sealing surface may be realized for example by a sealing body in the form of a solid cylinder. It is further conceivable to provide the sealing body as truncated cone or frustum. In addition to this or in case the sealing plug is provided as a hollow body, preferably the one end of the sealing body is provided with the radially circumferential sealing lip. This sealing lip protrudes radially outwardly from the sealing body and abuts preferably at the end of the component insert at the component insert. In this way, also a sealing function for the portion between the inner side of the sealing body and sealing plug is realized.

According to a preferred embodiment of the present invention, the mounting aid is a rod-shaped or peg-shaped extension. This extension extends in the axial direction of the sealing body and is arranged off-center or eccentrically relative to the axis of symmetry of the sealing body. Such a construction is especially advantageous when the wire thread insert to be moulded has a radially inwardly projecting peg. This peg partially blocks the lower through-hole of the wire thread insert so that only an eccentrically arranged web or peg as mounting aid may be threaded through this partially blocked opening. By means of the mounting aid it is in turn ensured that the sealing plug has a tight fit within the component insert or wire thread insert and also completely fills the interior of the component insert with respect to the length of the component insert. Of course, it is equally preferred to arrange the mounting aid in the center and therefore in continuation of the axis of symmetry of the sealing body.

According to a further preferred embodiment, the mounting aid has a tapering adjacent to the sealing body, so that the mounting aid is removable from the sealing body.

It was mentioned above already that the mounting aid ensures a reliable positioning of the sealing plug in the interior of the component insert. However, in order not to reduce the moulding of the component insert and the quality of the structural member to be produced due to the mounting aid, the mounting aid is preferably removed from the sealing plug before the moulding procedure. For this purpose, the mounting aid comprises a predetermined breaking point or separation point, which facilitates the removal of the mounting aid from the sealing plug. This separation point is, for example, a tapering of the mounting aid, so that by a sufficient tensile force in the axial direction of the mounting aid, it is removable from the sealing plug. It is also preferred to twist off the mounting aid from the sealing plug. For this purpose, the mounting aid may have preferably incisions or notches at which the mounting aid breaks away from the sealing body.

According to a further preferred embodiment of the present invention, the sealing body has a hollow-cylindrical shape in which an inner opening is adaptable to a core pin of a mould so that the hollow-cylindrical sealing body is radially expandable or widenable via the core pin within the inner opening of the component insert.

According to a further preferred embodiment of the present invention, the sealing body is in its axial direction at least as long as the component insert. Specifically, the sealing body is preferably adapted to the depth of the inner opening of the component insert so that the sealing body covers the entire inner surface of the component insert after insertion into the component insert, and thus closes or seals against the entering or pressing in of the hardenable, flowable material. In this context, it is also preferred to form the sealing plug longer than the component insert. In this way, it is ensured that the complete inner surface of the component insert is covered with the sealing body so that no flowable, curable material may enter or may be pressed into the interior of the component insert.

According to another preferred embodiment of the present invention, the component insert is a wire thread insert or a threaded insert with through hole and/or perforated side walls and/or shell openings. In accordance with an embodiment of the present invention, the wire thread insert is constructed as a wire sleeve. In this case, the coils of the wire sleeve are wound adjacent to each other to form an almost closed radial outer wall. In addition, such coils of the wire sleeve which are wound adjacent to each other are preferably wound in the geometry of a standard thread. On this basis, other threaded elements, such as screws, may be screwed directly into the wire sleeve. In addition, it is not necessary that the wire thread insert is fitted into a preformed thread to only then adopt the appropriate thread form and to be combinable with the male threaded elements.

It is also preferred that the radial outer side of the sealing body is elastically adaptable to the internal thread of the wire thread insert or of the threaded insert, or that the radial outer side of the sealing body comprises a structured shape which is adapted to the internal thread of the component insert.

In this context, it is furthermore preferred to provide the radial outer side of the sealing body, for example, with a thread matching to the radial inner side of the wire thread insert or the threaded insert so that the sealing body and the wire thread insert or threaded insert enter a positive or form-fit connection. In the same way, it is also preferred to provide the outer surface of the sealing body with a radially projecting structure, which realizes a sealing abutment on the inner side of the component insert.

According to another preferred embodiment of the present invention, the sealing plug comprises only one mounting aid. According to a further preferred embodiment, the sealing body comprises in addition to the first mounting aid a second mounting aid extending in the axial direction from the sealing body opposite to the first mounting aid. When using the first and second mounting aids in combination, it is preferred to set the first mounting aid and the second mounting aid under tension in opposite directions during the installation of the sealing plug into the component insert, and then to install the sealing plug into the component insert. Due to the opposite tensile stresses at the first and the second mounting aid, the sealing body is stretched in its axial direction and hence is also tapered radially. This facilitates an insertion into the inner opening of the component insert. Once the sealing body has reached its desired position, the first mounting aid and the second mounting aid are relieved, and the sealing body expands in the radial direction.

The present invention also discloses the already above discussed sealing plug according to the invention for the usage in a component insert. This sealing plug has the following features: a cylinder-like sealing body with a radial outer side, which is adaptable to a radial inner side of the component insert, wherein the sealing plug has a removable mounting aid at a closed end of the sealing body, so that the sealing plug is insertable into the component insert with the mounting aid rushing ahead.

Additionally, the present invention discloses a method for moulding a component insert into at least a flowable, curable or hardenable material or into a fibrous material soakable therewith. The inventive method comprises the steps of: closing the component insert with a sealing plug comprising a sealing body and a mounting aid by inserting the sealing body into the component insert with the removable mounting aid rushing ahead, holding the closed or sealed component insert with sealing plug at a predetermined position, at least partially surrounding the component insert with sealing plug with the flowable, curable or hardenable material or with a fibrous material soaked therewith, and curing or hardening of the material, and removing the sealing plug from the component insert.

According to further preferred embodiments of the present method, the component insert is initially positioned at a predetermined position with or without sealing plug. If the component insert has been positioned without sealing plug, the sealing plug is installed in the component insert subsequently. Provided that the component insert has been already positioned in a mould or the like, the component insert is now kept or hold at the predetermined position with sealing plug. It is also preferred to provide the component insert with the sealing plug outside of a mould or remote from the place of further processing. After that, the component insert with sealing plug is kept or held and maintained at the place of further processing at a predetermined position.

According to another preferred embodiment of the method, the component insert with sealing plug is moulded with or without mounting aid. Thus, the mounting aid is removed before the moulding of the component insert according to a method alternative. In case the installation space and the component insert to be produced allows it, it is also preferred that the mounting aid is kept or maintained at the sealing body. The same preferably also applies to the usage of two mounting aids. Since the second mounting aid is preferably arranged at the open side of the component insert, the second mounting aid does not need to be removed from the sealing body, but may be used to later remove the sealing plug from the component insert.

Within this method, it is preferred to provide the sealing plug with a sealing body which is hollow inside, preferably hollow cylindrical. Due to this hollow shape of the sealing body, the sealing plug with component insert is positionable and maintainable on a core pin, while being mould into the material surrounding it. Due to the attachment of the sealing body on the core pin, the sealing body is expanded or widened in the radial direction. This radial expansion causes that the sealing body abuts or rests against the inner side of the component insert and thus prevents an entering or pressing in of the flowable, hardenable material into the interior of the component insert. To this end, the core pin has a shape adapted preferably to the interior of the component insert to expand the sealing plug suitably. According to another embodiment, it is preferred to radially expand the sealing body which is formed hollow in the interior by means of the core pin by conveying or delivering air or another medium into the interior of the sealing body via the core pin. This medium delivered expands the sealing body radially so that also the sealing body abuts on the inner side of the component insert.

### 4. BRIEF DESCRIPTION OF THE ACCOMPANYING DRAWINGS

The present invention is explained in more detail with reference to the accompanying drawings. It shows:

FIG. 1 a preferred embodiment of the sealing plug according to the invention,

FIG. 2 a cross-sectional view of the sealing plug of FIG. 1,

FIG. 3 a cross-sectional view of another preferred embodiment of a sealing plug,

FIG. 4 a further preferred embodiment of the inventive sealing plug,

FIG. 5 a cross-sectional view of a preferred embodiment of the sealing plug of FIG. 1 in combination with a wire thread insert,

FIG. 6 a preferred embodiment of a combination of the inventive sealing plug with a component insert,

FIG. 7 a schematic illustration of inserting a preferred core pin according to the invention into the sealing plug with the wire thread insert,

FIG. 8 a schematic illustration of the preferred core pin according to the invention with medium supply openings during insertion into a preferred sealing plug according to the invention with wire thread insert,

FIG. 9 a schematic representation of a preferred sequence of the moulding of the wire thread insert with sealing plug into a webbing,

FIG. 10 a view of a preferred embodiment of the sealing plug in its axial direction from the side of the mounting aid,

FIG. 11 an enlarged view of a preferred embodiment of a portion of the sealing plug with mounting aid, and

FIG. 12 a flow chart of a preferred embodiment of a moulding method of the component insert with sealing plug into a flowable, curable material or into a webbing or fibrous material soaked therewith.

### 5. DETAILED DESCRIPTION OF THE PREFERRED EMBODIMENT

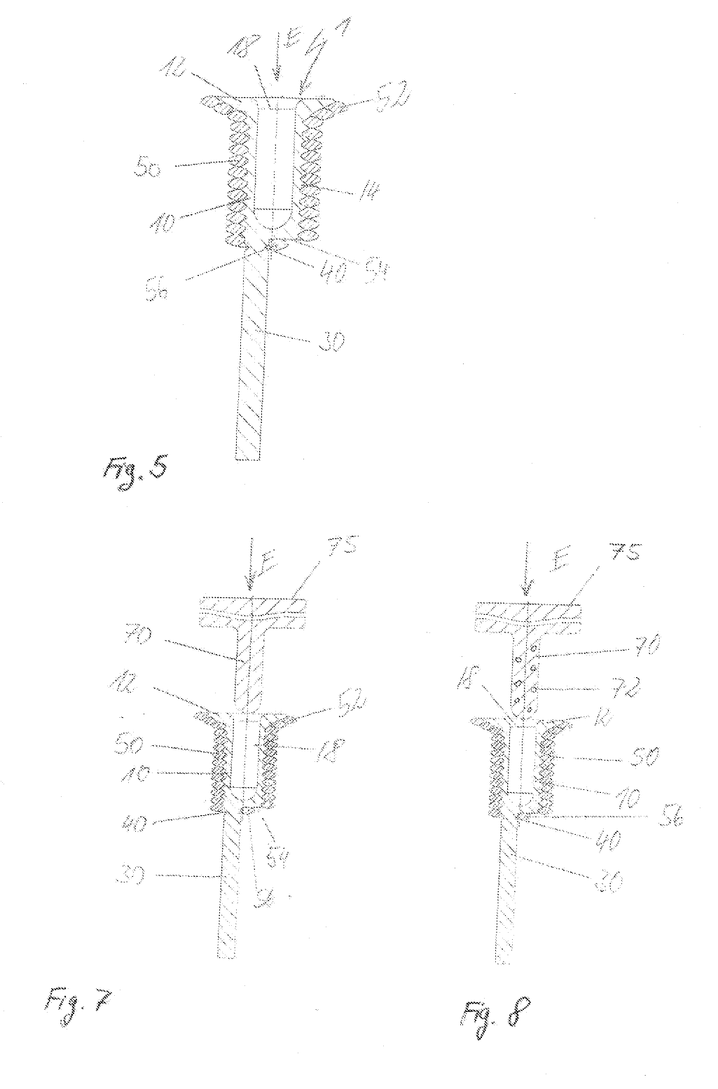

FIGS. 5 and 6 show preferred embodiments of a component insert 50; 60 with a sealing plug 1. This arrangement is adapted to be arranged and fixed in at least one flowable, curable or hardenable material, such as synthetic resins, plastics, metals, low melting cast alloys, or in a webbing or fibrous material soaked with such a flowable, curable material. The inventive sealing plug 1 prevents due to its positioning in the component insert 50; 60 that the flowable, hardenable material enters or presses into the interior of the component insert 50; 60. This is especially relevant for component inserts 50; 60 having a through bore, at least a shell opening, at least a side wall opening or generally lateral or front-end openings into which the flowable, hardenable material may enter or press in. An example of such a component insert is a wire thread insert, as shown at reference numeral 50.

Based on FIG. 5, it can be exemplarily seen that the wire thread insert 50 has turns which are arranged adjacent to each other, but which are not necessarily abutting each other in a sealing manner. If one places the wire thread insert 50 in a mould to mould it into a flowable, curable material or into a webbing or fibrous material soaked therewith, then the flowable, curable material may enter or press into the interior of the wire thread insert 50 between the turns of the wire thread insert 50. When the flowable material cures or hardens in the inside of the wire thread insert 50, an internal thread of the wire thread insert 50 is thereby glued and thus unusable.

A preferred embodiment of the wire thread insert 50 is illustrated in FIGS. 5, 7 and 8. Here, the turns of the wire thread insert are wound or wrapped adjacent to each other so that they form a threaded sleeve. This threaded sleeve is shown in FIGS. 5, 7, 8 with a sealing plug 10, which is explained in detail below. Despite the densely wound turns of the threaded sleeve 50, the radial preferably cylindrical outer wall of the threaded sleeve 50 which is formed by the turns must not be liquid-tight. The inner wall of the threaded sleeve 50 preferably forms a standard thread, so that a male threaded element is screwable in without further adjustment of the threaded sleeve 50. In addition, the inner wall of the threaded sleeve 50 specifies arbitrary threads in coordination with a male threaded element (not shown) to be screwed in.

In view of the above-described entering or pressing in of flowable, hardenable material into the interior of component inserts 60, the same as for the above-discussed wire thread inserts 50 applies. The flowable, curable material may enter or may be pressed into the interior of the component insert 60 via front-end or lateral openings. Such component inserts 60 are threaded inserts, connecting inserts having a keyhole or a structure for a bayonet closure or the like. Another example are sleeves for plug connectors of electrical or mechanical nature. An example of such a component insert 60 is shown in FIG. 6.

In order to be able to mould a component 50; 60 with front-end and/or lateral openings into a flowable, curable material or a webbing or fibrous material soaked therewith, the component insert 50; 60 is closed or sealed with a sealing plug 1. Exemplarily for a component insert 50; 60, the present invention will be described with reference to the wire thread insert 50. The wire thread insert 50 preferably consists of a plurality of turns which are superposed in the axial direction and which abut each other almost sealingly or not sealingly. According to a preferred embodiment of the present invention 50, the wire thread insert 50 comprises a flared or widened insertion opening 52. In the axial direction of the wire thread insert 50 opposite to the insertion opening 52, the wire thread insert 50 comprises another front-end opening 54. Since the wire thread insert 50 has a radially inwardly projecting peg 56, the front-end opening 54 is arranged eccentrically or off-center. Without the peg 56, the front-end opening 54 would be arranged centrally. With respect to other component inserts 60, it is also preferred that these also have a front-end opening 64, which is arranged centrally or eccentrically.

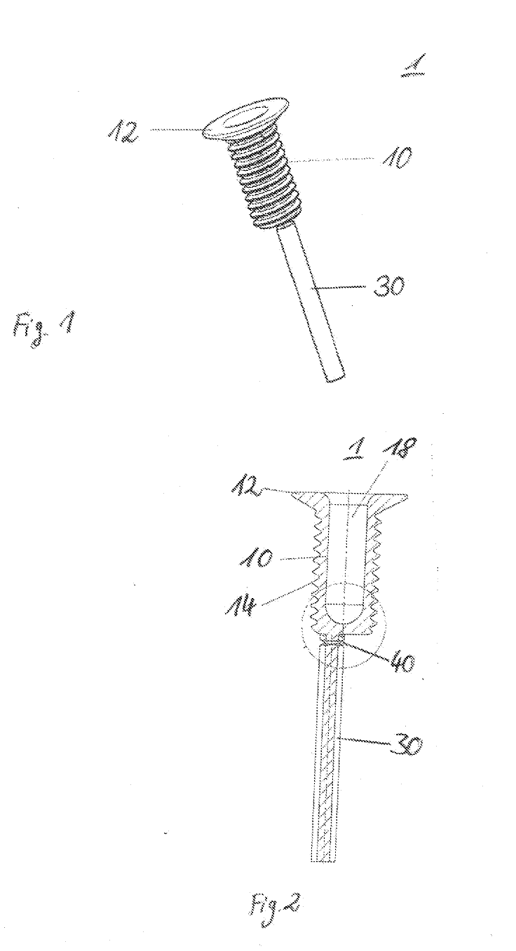

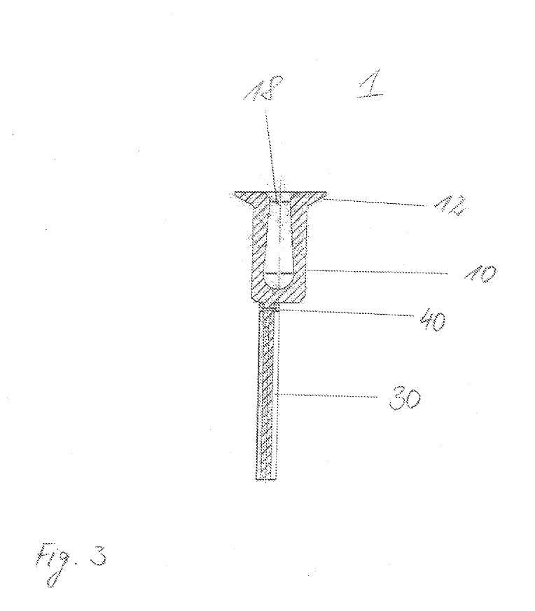

The inventively preferred sealing plug 1 for the wire thread insert 50 is shown in FIGS. 1 and 2 alone and in FIG. 5 in combination with the wire thread insert 50. The sealing plug 1 according to the invention consists of a material which is elastic and resistant to mechanical and chemical attacks, such as elastomeric materials and silicones. Further preferred materials for the sealing plug 10 are thermoplastic rubber, silicone rubber, flexible high temperature PVC or ethylene-propylene-Diem rubber (EPDM).

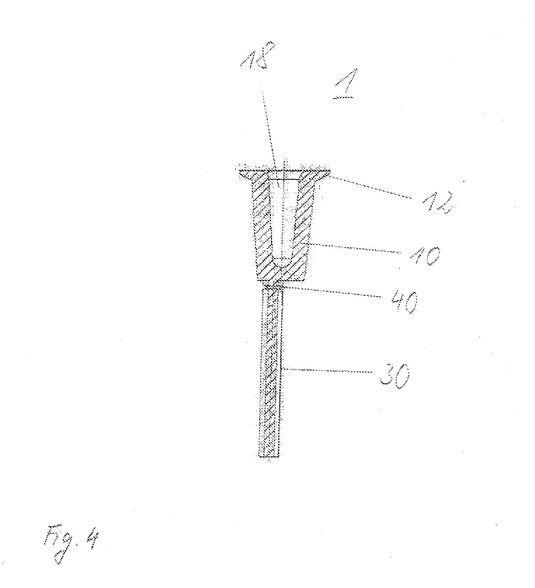

Structurally, the sealing plug 1 consists of a sealing body 10 having an optional sealing lip 12 and a mounting aid 30. The sealing body 10 is adapted in its shape and size to the component insert 50; 60. With respect to the wire thread insert 50, the sealing body 10, thus, preferably has a cylindrical or hollow cylindrical shape. In the same way, also conical or frustum-like shapes of the sealing body 10 meet the sealing function explained in greater detail below. While the hollow cylindrical shape of the sealing body 10 is illustrated in FIG. 2, a cylindrical shape is shown schematically in FIG. 3 and in FIGS. 4 and 6 a preferred conical shape of a sealing body 10 is shown schematically.

Functionally, size and shape of the sealing body 10 are designed so that they fill and seal the inner opening of the component insert 50; 60 on all sides. Therefore, the sealing body 10 is preferably at least as long as the wire thread insert 50, so that the inner opening of the wire thread insert 50 is sealable over its entire length in the radial direction and on the front-ends.

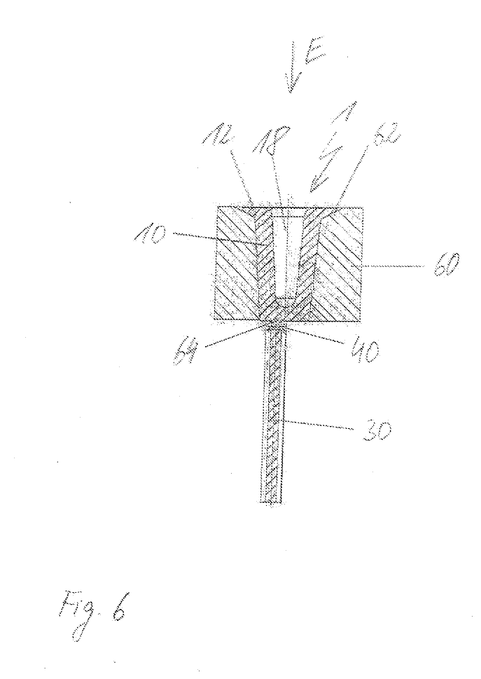

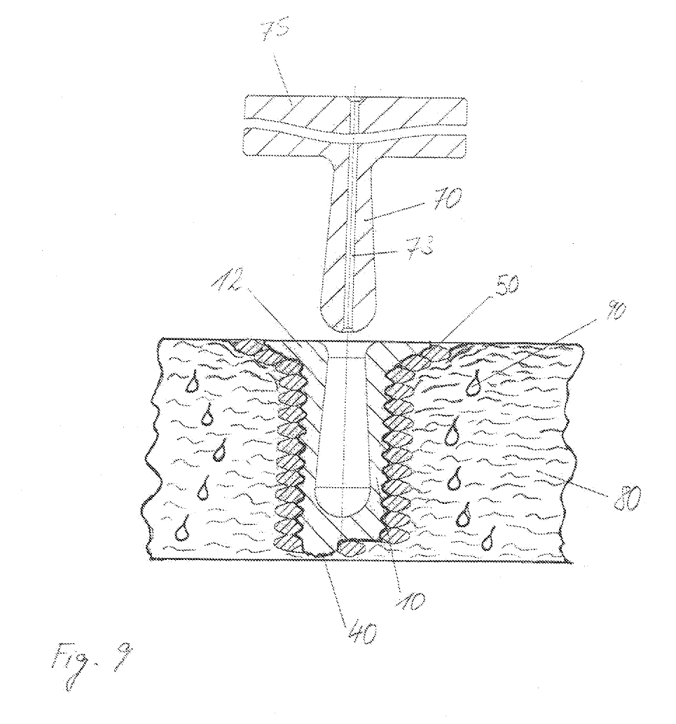

In its diameter, the sealing body 10 is preferably formed larger than the inner diameter of the inner opening of the wire thread insert 50 so that the radial outer walls of the sealing body 10 abut on the radial inner wall of the wire thread insert 5 in a tight and sealing manner. It is preferred, to form the sealing body 10 as a solid body (not shown) or with an inner opening 18. If the sealing body 10 comprises the inner opening 18 (cf. FIGS. 2 and 7), it is also preferred to radially expand or widen the sealing body 10 within the wire thread insert 50. This is for example possible via a core pin and its particular form or via the blowing in of a medium (cf. FIGS. 8 and 9), such as air, into the opening 18 (see below). To this end, the core pin 70 (see below) is produced with an excess with respect to the opening 18 in the sealing body 10, so that the sealing body 10 is pressed radially outwardly against the inner wall of the wire thread insert 50 or of the component insert 60. While on the one hand, the core pin 70 may create due to its shape certain deformations of the sealing plug 1 and in particular of the sealing body 10, it is also preferred to achieve certain deformations of the sealing body 10 by a shape of the inner opening 18. Therefore, the inner opening 18 is formed preferably cylindrical (FIG. 2), drop-shaped (FIGS. 3, 9) or conical (FIGS. 4, 6), wherein also other designs are preferred.

In order to further support the sealing by the sealing body 10, the outer surface of the sealing body 10 is preferably formed structured. According to a preferred embodiment, the sealing body 10 has an external or outer thread matching the thread of the wire thread insert 50. Further preferred are a smooth radially outer wall of the sealing body 10, or bead-shaped bulges in the radial outer wall of the sealing body 10 (not shown here).

To be able to install the sealing plug 1 with little effort in the wire thread insert 50, the mounting aid 30 is provided. The mounting aid 30 extends away from the sealing plug 10 in the axial direction and away from the front-end of the sealing plug 10, which is inserted first into the component insert 50; 60. As the sealing body 10 may be drawn easily into the wire thread insert 50 by means of the mounting aid 30, the mounting aid 30 is preferably formed longer than the wire thread insert 50. This allows the mounting aid 30 to be plugged easily through the wire thread insert 50 to be abel to pull or draw the sealing body then into the wire thread insert 50 by means of the protruding end of the mounting aid 30.

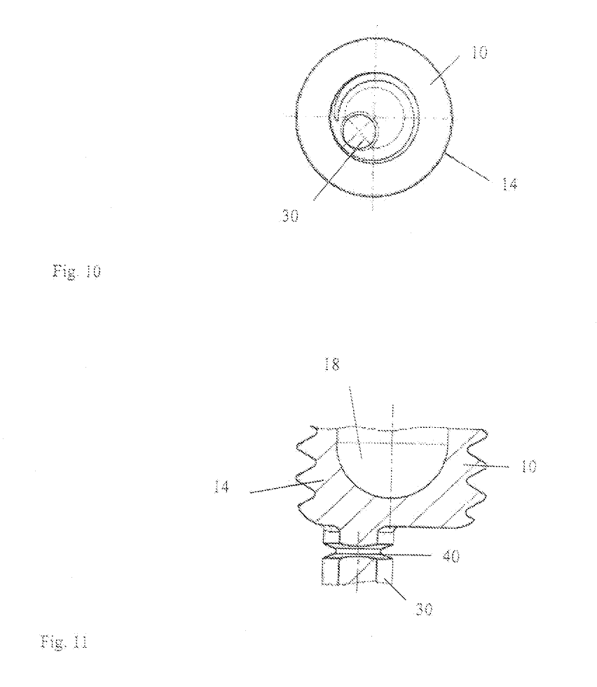

Depending on the front-end opening 54; 64 of the component insert 50; 60, the mounting aid 30 is arranged centrally or eccentrically (cf. FIG. 10) relative to the axis of symmetry of the sealing body 10. Since the wire thread insert 50 preferably has a central peg 56, the mounting aid 30 is arranged eccentrically. The central as well as the eccentric arrangement of the mounting aid 30 supports in the same way the mounting of the sealing plug 1 in the component insert 50; 60.

Before or after the component insert 50; 60 to be moulded, which is sealed with the sealing plug 1, is positioned in a mould or otherwise, the mounting aid 30 is removed. Otherwise, the mounting aid 30 might interfere with or hinder the moulding process, cause component defects or change the shape of the component unaesthetically. If the construction of the component to be produced should allow it, it is also preferred to keep the mounting aid 30 in the component.

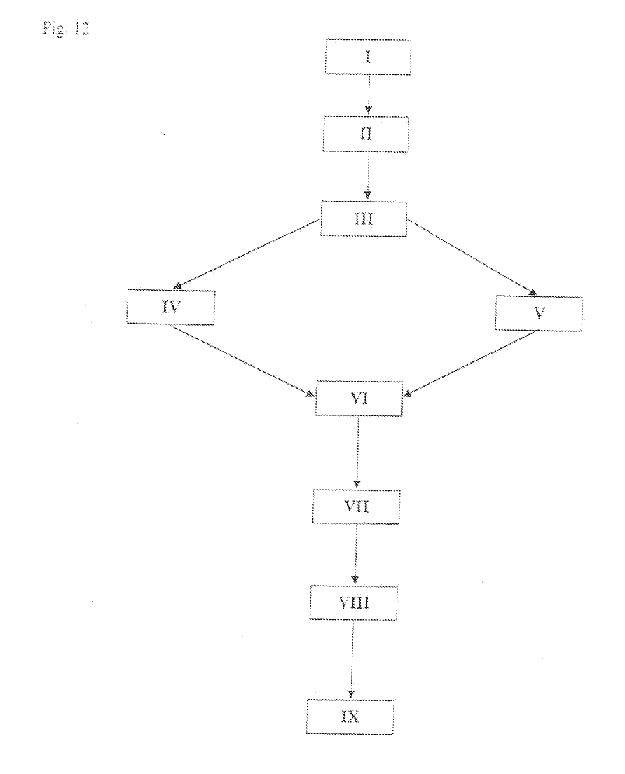

To remove the mounting aid 30, the mounting aid 30 preferably has a tapering 40, in particular a predetermined breaking point, via which it is removable from the sealing body 10. This is illustrated in FIG. 11 in particular, which reproduces the encircled region of FIG. 2 in an enlarged way. The tapering 40 is formed preferably radially circumferential or only partially circumferential or as a radial incision in the mounting aid 30. The tapering 40 forms a predefined failure point at which the mounting aid 30 is removable from the sealing body 10 without that the sealing body 10 loses its sealing function in the component 50; 60.

At the production of components, flowable, curable or hardenable materials are used, such as, for example, resin systems, as they have been mentioned above. According to a preferred embodiment, these materials are processed hot and harden during cooling. Other flowable materials are processed cold and are subsequently cured by heat supply. For example, a preferred cold resin system, preferably of epoxy resin, melamine resin, polyester resin or silicone resin, is used for soaking carbon fibers, webbings, mats, non-woven materials, and is cured by supplying heat. Similar methods are used for the processing to casting masses, press masses, laminates and cavity filling masses. If a component insert 50; 60 with sealing plug 1 is moulded into such a combination of materials, the interior of the component insert 50; 60 has to be sealed against the low-viscosity resin flow front of the cold resin system.

Referring to the flow chart in FIG. 12, a preferred manufacturing method of a component by means of the component insert 50; 60 with sealing plug 1 is described. First, in step I the component insert 50; 60 is sealed or closed with the sealing plug 1. For this purpose, the mounting aid 30 is inserted in the insertion direction E into the component insert 50; 60 until the mounting aid 30 protrudes out of the opening 54; 64, preferably at the front-end. By means of the protruding or projecting end of the mounting aid 30, the sealing body 10 is drawn into the component insert 50; 60.

Once the sealing plug 1 is positioned suitably in the component insert 50; 60, the mounting aid 30 is removed from the sealing body 10 (step II).

If the sealing body is a solid body 10 (cf. FIGS. 2 and 4), the component insert 50; 60 is positioned and held by appropriate positioning in the tool or in the mould halves. At a hollow cylindrical or hollow cylinder-like or otherwise shaped sealing body 10 with an inner opening 18 (cf. FIGS. 7, 8, 9), the sealing plug 1 with component insert 50; 60 is positioned on a core pin 70 within a tool half or tool mould (step III). It is also preferred to position the component insert 50; 60 first in the tool or tool half and to insert only thereafter the sealing plug 1 into the component insert 50; 60. According to preferred embodiments of the present invention, the sealing body 10 is expanded or widened by the geometry of the core pin (step IV) or by the introduction of a medium into the sealing body 10 (step V). This results in the sealing of the component insert 50; 60 to the outside by means of the sealing body 10. Exemplarily, FIG. 7 illustrates the core pin 70 without openings, FIG. 8 illustrates the core pin 70 having radial holes 72 and FIG. 9 illustrates the core pin 70 having an axial opening 73. Via the openings 72, 73 preferably air or another medium is introduced into the sealing body 10 in order to expand or widen it, preferably to radially widen it. Referring to FIG. 9, the core pin 70 is first inserted into the sealing body 10 and thereby seals the opening 18 by its radially expanded head 75. As soon as a medium is introduced into the opening 18, the latter cannot leave the opening 18 and leads to the expansion of the sealing body 10.

Thereafter, in step VI webbings, fibers, mats or the like are inserted into the tool and are layered above or laterally from the component insert 50; 60 with sealing plug 1 (step VI). There are different ways that are all equally preferred depending on the application, respectively. For example, the webbings may be expanded by spikes to then position the component insert 50; 60 with sealing plug in the widened sections. According to a further preferred embodiment, the thread insert 50; 60 with sealing plug 1 itself widens the webbings which are later to be soaked with curable, flowable material. A further embodiment is to cut the webbing layers and subsequently to position the component insert 50; 60 with sealing plug 1 in the incised or cut portions. According to the invention, it is further preferred to provide bores in the layers to be soaked in which the component insert 50; 60 with sealing plug 1 is positioned. According to a further preferred embodiment, the webbing layers are layered over the component insert 50; 60 with sealing plug 1 as far as this webbing layers have openings for receiving the component insert 50; 60 with sealing plug 1.

In the next step VII, the tool with therein positioned component inserts 50; 60 with sealing plug 1 and material to be soaked is closed. According to a preferred embodiment, the cold resin system is then injected into the mould to soak the webbing therein. According to a further preferred embodiment, a hot resin system is introduced into the mould to soak the material therein.

When using a cold resin system, the pre-soaked webbing is cured under pressure and temperature. In this case, this sealing plugs 1 remain within the component inserts 50; 60 arranged in the tool, since they have a sufficient heat resistance due to their material. When using a hot resin system, the material is cooled after the soaking of the material within the tool so that the hot resin system cures (step VIII).

After completion of the curing process in step VIII, the components are demoulded from the tool or the mould halves. The sealing plugs 1 are removed from the fixed component insert 50; 60 with little effort due to their elastic material, so that now a wear-free and clean thread without resin residues is present within the moulded component (step IX).

FIG. 9 illustrates schematically a wire thread insert 50 with sealing plug 1 from which the mounting aid 30 has been already removed. Since the sealing body 10 is hollow cylindrically shaped, the sealing plug 1 with wire thread insert 50 may be positioned on the core pin 70 in the tool. The core pin 70 expands or widens the sealing body 10 and thereby seals the wire thread insert 50. The sealing lip 12 seals the wire thread insert 50 in the axial direction against the core pin 70.

Thereafter, the webbing/the fibers are inserted into the tool or into the mould halves, wherein the webbing or the fibers are designated by the reference numeral 80. Subsequently, the webbing or the fibers 80 are soaked with the curable, liquid material 90, preferably resin. For curing the resin, the resin is cooled or heat is applied depending on the system (see above).

For moulding the workpiece, the core pin 70 is first removed from the sealing body 10. Subsequently, the component can be removed from the tool half and the sealing body 10 can be removed from the wire thread insert 50.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. Component insert with a sealing plug, wherein the component insert is moldable into at least a flowable, curable material or into a fibrous material soaked therewith so that an inner side of the component insert is kept free of the material, wherein the sealing plug comprises:
a. a cylinder-like sealing body having a radial outer side which is adaptable to the inner side of the component insert, wherein
b. the sealing plug comprises at least one removable mounting aid at a closed end of the sealing body, so that the sealing plug is insertable into the component insert with the mounting aid rushing ahead.

21. Component insert with sealing plug according to claim 20, the sealing body of which comprises at least one of a radially circumferential sealing lip or a front-end sealing surface at the end facing away from the mounting aid.

22. Component insert with sealing plug according to claim 20, the mounting aid of which is one of a web-like or peg-shaped extension which extends in the axial direction of the sealing body and is arranged eccentrically with respect to the axis of symmetry of the sealing body.

23. Component insert with sealing plug according to claim 20, the mounting aid being tapered adjacent to the sealing body, so that the mounting aid is removable from the sealing body.

24. Component insert with sealing plug according to claim 20, wherein the sealing body has a hollow cylindrical shape in which an inner opening is adapted to a core pin of a mold, so that the hollow cylindrical sealing body is radially expandable via the core pin within the inner opening.

25. Component insert with sealing plug according to claim 21, wherein the sealing body has a hollow cylindrical shape in which an inner opening is adapted to a core pin of a mold, so that the hollow cylindrical sealing body is radially expandable via the core pin within the inner opening.

26. The component insert with sealing plug according to claim 20, wherein the sealing body is at least as long as the component insert in its axial direction.

27. The component insert with sealing plug according to claim 21, wherein the sealing body is at least as long as the component insert in its axial direction.

28. The component insert with sealing plug according to claim 20, which is one of a wire thread insert or a threaded insert and in which either the radial outer side of the sealing body is elastically adaptable to the internal thread of the wire thread insert or of the threaded insert, or the radial outer side of the sealing body comprises a structured shape which is adapted to the internal thread of the component insert.

29. The component insert with sealing plug according to claim 21, which is one of a wire thread insert or a threaded insert and in which either the radial outer side of the sealing body is elastically adaptable to the internal thread of the wire thread insert or of the threaded insert, or the radial outer side of the sealing body comprises a structured shape which is adapted to the internal thread of the component insert.

30. The component insert with a sealing plug according to claim 20, in which the sealing body either has only one mounting aid, or wherein the sealing body has a first mounting aid and a second mounting aid extending in the axial direction from the sealing body opposite to the first mounting aid.

31. The component insert with a sealing plug according to claim 21, in which the sealing body either has only one mounting aid, or wherein the sealing body has a first mounting aid and a second mounting aid extending in the axial direction from the sealing body opposite to the first mounting aid.

32. The component insert with a sealing plug according to claim 22, in which the sealing body either has only one mounting aid, or wherein the sealing body has a first mounting aid and a second mounting aid extending in the axial direction from the sealing body opposite to the first mounting aid.

33. Sealing plug for use in a component insert having the following features:
a) a cylinder-like sealing body having a radially outer side which is adaptable to a radial inner side of the component insert, wherein
b) the sealing plug comprises a removable mounting aid at a closed end of the sealing body, so that the sealing plug is insertable into the component insert with the mounting aid rushing ahead.

34. Sealing plug according to claim 33, in which the sealing body comprises at least one of a radially circumferential sealing lip or a front-end sealing surface at an end facing away from the mounting aid.

35. Sealing plug according to claim 33, the mounting aid of which has the shape of one of a web-like or peg-shaped extension extending in the axial direction of the sealing body eccentrically relative to the axis of symmetry of the sealing body.

36. Sealing plug according to claim 35, in which the mounting aid is tapered adjacent to the sealing body, so that the mounting aid is removable from the sealing body.

37. Sealing plug according to claim 33, the sealing body having one of a hollow cylindrical or conical shape which is closed at one side, so that the sealing body is radially expandable via its inner opening.

38. Sealing plug according to claim 34, the sealing body having one of a hollow cylindrical or conical shape which is closed at one side, so that the sealing body is radially expandable via its inner opening.

39. Sealing plug according to claim 33, in which either the radial outer side of the sealing body is elastically adaptable, or the radial outer side of the sealing body has a structured form.

40. A method for molding a component insert into at least a flowable, curable material or into a firbous material soaked therewith, comprising the steps of:
a) closing the component insert with a sealing plug comprising a sealing body and a mounting aid by inserting the sealing body into the component insert with the mounting aid rushing ahead;
b) holding the sealed component insert with sealing plug at a predetermined position;
c) at least partially surrounding said component insert with sealing plug with the flowable, curable material or with a fibrous material soaked therewith and curing of the material; and
d) removing the sealing plug from the component insert.

41. The method according to claim 40, comprising the further step of:
positioning the component insert with or without the sealing plug at the predetermined position.

42. The method according to claim 40, comprising the further step of:
removing the mounting aid from the sealing body after the sealing plug has been inserted in the component insert.

43. The method according to claim 40, wherein the sealing plug has an inner hollow formed sealing body, so that the sealing plug with component insert is positionable and holdable on a core pin.

44. The method according to claim 43, comprising the further step of:
expanding the sealing body of the sealing plug by means of at least one of a shape of the core pin or a pressure meansdelivered through the core pin.
